(19) United States
(12) Patent Application Publication
(10) Pub. No.: US 2009/0018021 A1
(43) Pub. Date: Jan. 15, 2009

(54) Methyl jasmonate decreases fruit detachment force of grapes

(75) Inventors: Matthew W. Fidelibus, Fresno, CA (US); Jacqueline K. Burns, Auburndale, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Regents of the University of California, Oakland, CA (US)

(21) Appl. No.: 12/004,119

(22) Filed: Dec. 19, 2007

Related U.S. Application Data
(60) Provisional application No. 60/876,606, filed on Dec. 22, 2006.
(60) Provisional application No. 60/950,004, filed on Jul. 16, 2007.

(51) Int. Cl. A01N 37/06; A01P 21/00

(52) U.S. Cl. 504/307

(57) ABSTRACT

The invention provides compositions and methods for harvesting grapes. Solutions comprising methyl jasmonate effectively loosen grapes from the stem. This allows the grapes to be harvested without damage to the fruit or plant associated with traditional mechanical harvesting and thereby eliminates the need for expensive hand picking.

### CROSS-REFERENCE TO RELATED PATENT APPLICATIONS

The present patent application claims benefit of priority to U.S. Provisional Patent Application No. 60/876,606, filed Dec. 22, 2006, and U.S. Provisional Patent Application No. 60/950,004, filed Jul. 16, 2007, each of which are incorporated by reference in their entirety.

### BACKGROUND OF THE INVENTION

Many California grape growers rely on hand labor to pick their grapes. For raisin-making, the grapes are then placed on paper trays between the vine rows to dry. However, labor has become increasingly scarce and expensive in recent years, so many growers have begun to use mechanical harvesters to shake the berries from the vines into hoppers from which they are spread onto a length of paper known as a ‘continuous tray’ (Christensen, Background and Resources, p 3-6, in: LP Christensen (ed.) Raisin Production Manual, UC Agricultural and Natural Resources Communications Services, Oakland, Calif. (2000)). The continuous tray method requires fewer laborers than the traditional hand harvesting method and can reduce production cost (Vasquez et al., Sample Costs to Produce Raisins, Department of Agricultural and Resource Economics, Davis, Calif. p. 19 (2007)). However, the harvest machines can cause sufficient mechanical damage to grapes to render them unsuitable, e.g., for wine or raisin-making.

Damage to the grapes can be minimized by severing the canes about one week prior to harvest (Studer and Olmo, Transactions ASAE 17:783-786 (1974)). Cane severance causes the rachises to dry and become brittle, facilitating berry shatter (Studer and Olmo, Transactions ASAE 14:38-43 (1971); Studer and Olmo, 1974). Berries on dried rachises tend to detach with their pedicels (cap-stems) attached (Studer and Olmo, 1971) which reduces rupturing and tearing (Studer and Olmo, 1974). However, some canes are inevitably missed by the pruning crews, and a proportion of the crop is born on basal shoots from spurs, or from the head of the vine, and thus not affected by cane severance. Berries harvested from clusters on non-severed shoots will reduce the overall quality of the crop (Studer and Olmo, 1974), so a more effective fruit loosening treatment is desirable.

Fruit loosening agents have applications for grapes used for the table, juice, raisins, and wine. For example, sound individual grape berries are desired by the food service industry for use in salads, and better quality wine may be made from fruits with less mechanical damage after machine harvest (Meyer, Amer J Enol Vitic 108-117 (1969)).

Despite the potential advantages provided by an abscission agent, few such agents have been identified (Weaver and Pool, Amer J Enol Vitic 19:121-124 (1968)). Weaver and Pool showed that morphactins weakened the attachment of mature grapes to their clusters, but these synthetic compounds would likely be prohibitively expensive to register as a crop treatment, particularly since they are not used on other fruit crops. Ethephon sometimes promotes the loosening of grapes, but its efficacy is very inconsistent (Christensen, 2000). No other compounds are known to promote loosening or abscission of mature grape berries. Thus, it is an object of the invention to provide an effective abscission agent for grapes used for all purposes.

### BRIEF SUMMARY OF THE INVENTION

The invention provides methods and compositions to improve harvest methods of grapes. Treatment of grape plants and attached grapes with a composition comprising methyl jasmonate (MeJA), or an analog thereof, allows the grapes to be removed from the stems with less fruit detachment force (FDF) than that required for untreated grapes.

Accordingly, the invention provides a composition for the treatment of grapes, comprising MeJA, or an analog thereof. In some embodiments, the concentration of MeJA, or an analog thereof, in the composition is between 0.1 mM and 50 mM in the composition. In other embodiments, the concentration of MeJA, or an analog thereof, is between 0.2 mM and 20 mM, or between 2 mM and 20 mM in the composition. In some embodiments, the concentration is greater than 10 mM, for example, between 10 mM and 20 mM or between 10 mM and 30 mM. In some embodiments, the amount of MeJA contacted to a grape plant is sufficient to substantially reduce the FDF, but does not substantially affect leaf detachment.

In some embodiments, the composition further comprises an adjuvant. Appropriate adjuvants include spreader-sticker adjuvants. In some embodiments, the adjuvant is Latron-B 1956™. In some embodiments, the adjuvant is between 0.01% and 1% volume/volume of the composition. In other embodiments, the adjuvant is between 0.1% and 0.5% volume/volume of the composition.

In addition, the invention provides methods for harvesting grapes, comprising the steps of: contacting a fruiting grape plant with a composition comprising MeJA, or an analog thereof, wherein the concentration of MeJA or analog is sufficient to reduce the fruit detachment force (FDF) required to harvest the grapes compared to that of an untreated plant, and harvesting the grapes.

In another embodiment, harvesting comprises applying at least 10% less FDF than required to harvest untreated grapes. Often, harvesting comprises applying at least 50%, 60%, 70%, 80%, or 90% less FDF than required to harvest untreated grapes. In some embodiments, no FDF is applied, and harvesting comprises collecting grapes that have separated from the stem.

In some embodiments, the fruiting grape plant is treated with a composition comprising MeJA, or analog thereof, for a time sufficient to reduce the fruit detachment force (FDF) required to harvest the grapes from the plant when compared to the FDF required for untreated plants. In some embodiments, the grapes are harvested no more than one month after treatment with the composition. In some embodiments, the grapes are harvested no more than 16, 15, 14, 13, 12, 11, or 10 days after treatment (DAT). In other embodiments, the grapes are harvested less than 10 DAT, e.g., 3-9 DAT, 5-9 DAT, or 8-9 DAT.

In another aspect of the invention, the grapes are table grapes. In another embodiment, the grapes are wine grapes. In yet another embodiment, the grapes are raisin grapes. In certain aspects of the invention, depending on the purpose for which the grapes will be used, the grapes are selected from the group consisting of: Thompson Seedless (Syn. Sultanina), Black Corinth (Syn. Zante Currant), Crimson Seedless, Flame Seedless, Selma Pete, Concord, Muscadine, Cabernet Sauvignon, Cabernet franc, Chardonnay, Fiesta, Merlot, Grenache, Gamay, Sauvignon blanc, Chenin blanc, Pinot gris, Pinot noir, Pinot blanc, Pinot meunier, Pinotage, Mourvedre, Syrah, Petit syrah, Sangiovese, Gewurztraminer, Riesling, Muscat, Semillon, Zinfandel, Sylvaner, Rousanne, Viognier, Trebbiano, Muscadelle, Greltliner, Verdicchio, Barbera, Carignane, Nebbiolo, Malbec, Tempranillo, Montpulchian, Chianti, Tinta Cao, Tinta barroca, Tinta roriz, Cinsault, Grignolino and Dolcetto.

The invention provides methods for making raisins, comprising the steps of: contacting a fruiting grape plant with a composition comprising MeJA, or an analog thereof, wherein the concentration of MeJA or analog is sufficient to reduce the FDF required to harvest the grapes compared to that of an untreated plant, and harvesting the grapes. In some embodiments, harvesting comprises collecting grapes that have separated from the stem no more than one month after treatment. In some embodiments, the harvested grapes are further subjected to drying, e.g., in the field. In other embodiments, the grapes are harvested using the continuous tray method.

The invention also provides a method of harvesting grapes for wine, comprising the steps of: contacting a fruiting grape plant with a composition comprising MeJA, or an analog thereof, wherein the MeJA or analog is sufficient to reduce the FDF required to harvest the grapes compared to that of an untreated plant, and harvesting the grapes. In some embodiments, the grapes are harvested less than 14 DAT, and may be harvested less than 10 DAT.

### BRIEF DESCRIPTION OF THE DRAWINGS

FIG. 1 illustrates a cluster of Thompson Seedless grapes from a vine 10 DAT with a solution of 4500 ppm methyl jasmonate.

FIG. 2 shows that berries released from methyl-jasmonate-treated clusters were generally free of plugging and tearing.

FIG. 3 is a graph of average fruit detachment force (FDF) of Crimson Seedless grapes as a function of the concentration of methyl jasmonate applied. Points are treatment means, n=5 ten-berry samples. Fruit detachment force=0.80+−1.075⁻⁴•[methyl jasmonate], r²=0.99.

FIG. 4 is a bar graph comparing the FDF of berries from Cabernet Sauvignon and Merlot grapevines treated with 0 or 4500 ppm methyl jasmonate, 14 DAT. Within each cultivar, differences in FDF were significant according to analysis of variance, p<0.05.

### DETAILED DESCRIPTION OF THE INVENTION

The invention involves the surprising discovery that treatment of grapes with the natural plant hormone methyl jasmonate (MeJA) leads to abscission of the grapes or greatly reduces the fruit detachment force (FDF) required to harvest the grapes from the stems.

Harvesting following treatment with MeJA, or an analog thereof, has several advantages over traditional loosening techniques that involve cane severance. MeJA causes little damage to the canopy, minimizes damage to the grapes, and results in negligible non-grape solids in the harvest. Moreover, MeJA loosens grapes on all of the vines, while cane severance inevitably misses a significant portion of the fruit. In addition, by reducing the FDF required to harvest the grapes from the stems, MeJA treatment allows growers to take advantage of harvest machines without risking damage to the berries or vines. Thus, expensive hand-picking is not required.

MeJA treatment offers additional advantages. It results in a dry scar on the stem end of the grape that, e.g., prevents contamination and damage of the fruit after abscission enhances the quality of the grape for fresh consumption. For example, in muscadine grapes (Muscadinia rotundifolia) as well as other grape varieties typically harvested as single grapes rather than in clusters, a “dry” stem scar enhances the quality of the grape for fresh consumption. In addition, unlike coronatine, MeJA does not turn fruit brown in the sun.

### DEFINITIONS

As used herein, “abscission” refers to the process whereby a plant sheds a part, e.g., a fruit or grape. An “abscission agent” is an agent that promotes abscission of fruit from the stem.

The term “grape” as used herein refers to the fruit of a plant in the family Vitaceae. The fruit of a Vitaceae plant is also commonly referred to as a “berry.” Grapes are used for various purposes in the food industry including juice, wine, raisins, and table grapes for eating. Grape species include but are not limited to: Muscadinia rotundifolia, Vitis labrusca, Vitis vinifera and hybrids thereof (e.g., Vitis X labruscana). Vitis X labruscana L. H. Bailey, would include the cultivar Concord, whose fruits are widely used for juice and jelly. Grape varieties also include, but are not limited to: Thompson Seedless (Syn. Sultanina), Black Corinth (Syn. Zante Currant), Crimson Seedless, Flame Seedless, Fiesta, Selma Pete, Muscadine, Cabernet sauvignon, Cabernet franc, Chardonnay, Merlot, Grenache, Gamay, Sauvignon blanc, Chenin blanc, Pinot gris, Pinot noir, Pinot blanc, Pinot meunier, Pinotage, Mourvedre, Syrah, Petit syrah, Sangiovese, Gewurztraminer, Riesling, Muscat, Semillon, Zinfandel, Sylvaner, Rousanne, Viognier, Trebbiano, Muscadelle, Greltliner, Verdicchio, Barbera, Carignane, Nebbiolo, Malbec, Tempranillo, Montpulchian, Chianti, Tinta Cao, Tinta barroca, Tinta roriz, Cinsault, Grignolino and Dolcetto.

As used herein, the term “fruiting grape plant” refers to a plant from the family Vitaceae with fruit on the plant.

The term “adjuvant” refers to an agent that improves the effectiveness of the treatment of the plant. For example, the adjuvant may allow the active ingredient to adhere to the plant better. The adjuvant may improve the absorption of the active ingredient. The adjuvant may be a “sticker-spreader,” such as Latron B-1956™.

### Compositions to Promote Abscission

As noted above, relatively few agents are known that promote abscission of grapes from the vine. Morphactins weaken the attachment of mature grapes to their clusters, but these synthetic compounds are not yet registered as a crop treatment. Ethephon sometimes promotes the loosening of grapes, but its efficacy is very inconsistent.

Methyl jasmonate (MeJA) is a naturally occurring plant hormone. MeJA signals are generally associated with stress, such as wounding or damage from insects or other plant pathogens. MeJA treatment of plants affects expression of various defensive genes, including e.g., genes associated with secondary metabolism, proteinase inhibitors and storage proteins (see, e.g., Gundlach et al., Proc. Natl. Acad. Sci., 89:2389 (1992); Sasaki et al., DNA Res. 8:153-161 (2001)).

Analogs of methyl jasmonate are also effective for promoting abscission of grapes. Analogs include jasmonic acid and its derivatives that have the general structure:

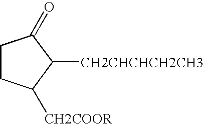

(see, e.g., U.S. Pat. No. 7,176,163). Particularly useful methyl jasmonate analogs of this structure have the R isomer at the C3 chiral center (see, e.g., Holbrook et al. (1997) Plant Physiol. 114:419-428). Additional methyl jasmonate analogs include CMN-pyrazole and coronafacic acid (see, e.g., Uppalapati et al. (2005) Plant J. 42:201-217) as well as jasmonic acid.

The invention provides compositions to promote abscission of grapes comprising methyl jasmonate or an analog thereof. In some embodiments, the composition is an emulsion or a liquid. The amount of MeJA, or analog thereof, is sufficient to reduce the fruit detachment force (FDF) required for harvest compared to an untreated plant. The optimal concentration of MeJA will vary depending on the type of grape, the environmental conditions, and desired method of harvest. One of skill in the art will understand how to adjust the concentration to optimize abscission in each situation. The concentration of MeJA may be expressed as mM or as parts per million (ppm), where 1 mM MeJA is equivalent to 225 ppm.

In some embodiments, the concentration of MeJA, or analog thereof, when applied to grapes is between 0.1 mM and 50 mM. For example, MeJA or the analog may be present between 0.2 mM and 20 mM, e.g., between 2 mM and 20 mM, in the composition, e.g., at a concentration of 0.5, 1, 2, 3, 4, 5, 6, 7, 8, 9, 10, 11, 12, 13, 14, 15, 16, 17, 18, 19 or 20 mM. In some embodiments, the concentration is greater than 10 mM, for example, between 10 mM and 20 mM or between 10 mM and 30 mM. In such embodiments, MeJA or an analog thereof can be present at, for example, between 11 mM and 15 mM, between 16 mM and 20 mM, between 21 mM and 25 mM, or between 20 and 35 mM. In other embodiments, the concentration is less than 10 mM, for example, between 0.2 and 2 mM. As noted above, these numbers generally refer to the concentration of MeJA in the composition as it is applied to a fruiting grape plant.

In some embodiments, one or more adjuvants are included in the composition comprising MeJA, or an analog thereof. Adjuvants help to improve, e.g., wetting, spreading, penetration, and overall efficacy of the treatment. In addition, some adjuvants improve rainfastness or prevent foaming so that application is more effective. In some embodiments, the adjuvant is a spreader-sticker adjuvant. Adjuvants include those primarily based on oils, silicon, glycol, alcohol, polysiloxane, limonene, or fatty acid esters. Adjuvants generally comprise both nonionic and ionic components for even spreading and optimal interaction with the selected treatment. One of skill in the art will understand that certain adjuvants may be more suited to certain conditions. For example, for crops that will be exposed to rain or irrigation, a more water resistant adjuvant may be selected.

Several agricultural adjuvants are commercially available, including Latron-B 1956™, Latron AG-98™, Latron CS-7™ (Rohm and Haas, Philadelphia, Pa.), Sylgard® 309 (Wilbur Ellis, San Francisco, Calif.), Citron (Intx Microbials, Kentland, Ind.), Adigor, CA237, or Output (Syngenta, Cambridge, UK), Sylwet L-77® (Momentive Performance Materials, Wilton, Conn.), Tween, and Dow Corning® (Midland, Mich.) Antifoam, Superwetting, and Surfactant agents, to name a few.

In some embodiments, the adjuvant is between 0.01% and 5% by volume in the solution as it is applied a fruiting grape plant. In particular embodiments, the adjuvant is between 0.1% and 1% by volume.

The above-described concentrations relate to concentrations for application on grapes. However, in some embodiments, the more concentrated compositions are formulated for commercial sale. For example, the composition comprising MeJA may be formulated at 2 to 1,000-fold, 10,000-fold, 100,000-fold or more higher concentrations, e.g., for more convenient packaging and shipping, and later diluted to one of the concentrations described above. One of skill in the art will understand how to adjust the concentration of both MeJA and the adjuvant, if present. For the purpose of illustration, a 10-fold concentration may comprise 150 mM MeJA and 2% adjuvant. The user would then dilute the concentrate 10-fold before application so that the final concentration would be 15 mM MeJA and 0.2% adjuvant.

### Methods of Treating Grapes

The MeJA compositions of the invention may be applied by any method for applying substances to plants and crops. Such methods are well known to those of skill in the art and include spraying by hand, with a machine or pump, or overhead spraying, e.g., from a plane. For the methods of the invention, the composition is contacted with the grape and/or the plant.

The compositions of the invention are generally liquid, and thus are conveniently applied to the grapes using a spray device. The nozzle of such a device is important for determining the range of the spray, as well as droplet size. Droplets are measured in volume median diameter (VMD). The American Society of Agricultural and Biological Engineers (ASABE) developed a drop size classification system (ASABE standard S-572). It contains six categories that range from very fine (<100 VMD) to extremely coarse-sized drops (>450 VMD). The optimal droplet size will vary depending on the particular environmental conditions and the amount of foliage on the grape vines.

### Methods of Grape Harvesting

The present invention provides an improvement over previous methods of harvesting grapes, by making it easier to separate each grape from its stem. The method of harvesting will often depend on the purpose for which the grapes will be used and the size and configuration of the trellised vines.

According to the methods of the invention, the grapes are harvested within a sufficient time period following treatment with MeJA such that FDF of the fruit is reduced compared to untreated plants. In some embodiments, the grapes are harvested less than one month after treatment. However, depending on conditions and the variety of grape, the compositions of the invention will take more or less time to loosen the berries to the desired level. In some embodiments, the grapes are harvested less than three weeks after treatment, or less than about 21 days after treatment (DAT). In other embodiments, the grapes are harvested less than about 14 or 15 DAT, and may be harvested 10, 11, 12, or 13 DAT. In other embodiments, the grapes are harvested less than 10 DAT, e.g., 3-9 DAT, 5-9 DAT, or 8-9 DAT.

Methods of harvesting include hand picking and machine harvesting. Harvesting machines have several different designs. Some simply separate each bunch of grapes from the vine and rely on subsequent hand separation of each berry (see, e.g., U.S. Pat. No. 7,080,498). Others employ shaking, e.g., in a sinusoidal or pseudo-sinusoidal motion, or alternate high and low speed shaking (see, e.g., U.S. Pat. No. 4,707,973). Many include conveyers to collect fruit as it is harvested (see, e.g., U.S. Pat. No. 6,557,335).

Grapes intended for raisins are generally harvested by continuous tray (CT) or “dried on vine” (DOV) methods. In CT, the grapes are mechanically harvested and laid on a long sheet to dry between the vine rows. CT methods generally rely on mechanical harvesting so the grapes and foliage suffer significant damage. In DOV methods, canes bearing mature fruit are severed, causing them to dry into raisins on the trellised rows for subsequent mechanical separation. These methods require careful trellis design to ensure that the grapes will receive sufficient sunlight while still on the vine.

In some embodiments, harvesting simply comprises collecting fruit that has dropped from the vine without mechanical detachment. In such cases, a drape or other collection device is placed beneath the grape vines before the grapes drop. In some embodiments, the grapes are then left in the collection device to dry, e.g., for raisin production.

### EXAMPLES

### Example 1

### Thompson Seedless Experiment

### Materials and Methods

An experiment was conducted in a 40-year-old Thompson Seedless vineyard at the Kearney Agricultural Center in Parlier, California. The site was typical of conventional raisin vineyards, with head-trained, cane-pruned vines on a two-wire T-shaped trellis with a 0.6 m cross arm. The soil was a deep Hanford fine sandy loam.

The vineyard was divided into plots consisting of vine sections (within-row spaces between two adjacent vine trunks) of uniform appearance and crop load. Each plot was surrounded by guard vines within and between rows. Treatments consisted of 26 different solutions made up of various potential abscission agents (Table 1). Because the concentrations varied widely between agents, each solution was considered a different treatment, and a randomized complete block design was used. All treatments, except for coronatine, were replicated four times. Due to a lack of material, coronatine was only applied to two plots; therefore, data from that treatment were not subjected to statistical analysis though observations were made.

Composite berry samples were collected weekly to monitor soluble solids accumulation by the fruits. Samples consisted of about 100 berries collected from the top, middle and bottom of about 33 randomly selected clusters. Berries were homogenized in a blender, their juice filtered, and soluble solids measured with a temperature compensating digital refractometer (Palette 101, Atago, Farmingdale, N.Y.). Once the fruits amassed sufficient soluble solids for raisin making (>19 Brix), abscission agents were dissolved or dispersed in water with adjuvant added (0.1%, v/v, Latron B-1956™, Britz, Parlier, Calif.) except MeJA solutions which contained 0.2% adjuvant. Control solutions contained the adjuvant only (0.2% v/v). Immediately after their preparation, solutions were applied to the vines of each plot with a gasoline-powered back-pack sprayer (Solo, Newport News, R.I.) until runoff. Vines within harvest pruned (HP) plots were not treated with any solutions, but their canes were severed on the same day that solutions were applied.

The soil surface within each plot was covered with ground cloth to collect any berries that might fall from the canopy. Ten days after treatment (DAT), berry abscission was only observed in plots treated with MeJA or coronatine. In those plots and in the control and HP plots, all abscised berries were collected from the ground cloth into paper bags and placed in a forced air oven (60 C) until they reached a constant weight. Clusters of grapes on vines from all the plots were carefully harvested and brought into a laboratory where fruit detachment force (FDF) measurements were made. Any grapes that detached from the vines at harvest were considered to be retained by the vine until harvest. These berries were collected into paper bags and placed in a forced air oven to dry.

Three representative clusters were selected from all the clusters of each plot and ten rachis sections from the top, middle, and bottom of the three clusters were removed by cutting the rachis with shears. A berry from each section was placed in a jig attached to a force gauge (DPS-11, Imada Inc., Northbrook, Ill.). The rachis was pulled parallel to the fruit axis until it separated from the fruit. The force required to detach each berry from the rachis in grams-force was recorded as the fruit detachment force. The condition of each detached berry was noted, and the berries were placed in paper bags along with all the other berries that were picked from that plot. These berries were also placed in the forced air oven and dried to a constant weight. The proportion of berries that abscised from the vine was calculated on a dry weight basis by dividing the dry weight of the abscised berries in each plot by the combined weight of the retained and abscised berries in that plot. Finally, canopy damage in each plot was inspected visually and assigned a rating of 0 (no obvious foliar damage), 1 (appearance of slight foliar damage), 2 (appearance of moderate foliar damage), or 3 (appearance of severe foliar damage).

Each plot was inspected again six months later when bud break and shoot growth were evaluated. To evaluate bud break, plots received one of the following scores; 0=shoots emerged from 0-20% of nodes; 1=shoots emerged from 20-40% of nodes, 2=shoots emerged from 40-60% of nodes, 3=shoots emerged from 60-80% of nodes, or 4=shoots emerged from 80-100% of nodes. Shoot growth in each plot was also evaluated on a five-point scale, based on the proportion of shoots that had progressed to the five-leaf stage (Eichorn-Lorenz stage 12; Eichorn and Lorenz, Phaenologische Entwicklungsstadien der Rebe. Nachrichtenbl. Deut. Pflanzenschutzd. (Braunschweig) 29:119-120 (1977)). A score of 0 indicated that 0-20% of the shoots had progressed to the five-leaf stage, 1=21-40% of the shoots progressed to that stage, 2=41-60% of the shoots, 3=61-80% of the shoots, and 4=81-100% of the shoots had progressed to the five-leaf stage.

All data were subjected to analysis of variance using the general linear models procedure (PROC GLM) of SAS statistical software (SAS Inst., Cary, N.C.). Duncan's New Multiple Range Test was used to separate treatment means.

TABLE 1
Abscission Agents Tested on Grapes

| Compound | Description | Concentrations tested |
|---|---|---|
| ACC | The ethylene biosynthetic precursor. | 50 and 150 ppm |
| | Can readily be converted to ethylene | |
| | in plants (Wang et al., 2004), but | |
| | uptake can be an issue. Like | |
| | ethephon, may induce non-specific | |
| | abscission. | |
| 5-chloro-3-methyl-4- | Specific for mature citrus fruit | 20, 200, 1000, and 2000 ppm |
| nitro-1H-pyrazole | loosening within a wide | |
| (CMNP) | concentration range (Burns, 2002). | |
| Coronatine | A natural compound produced by | 200 ppm |
| | fermentation with Pseudomonas | |
| | syringae pv glycinea. Is classified as | |
| | a methyl jasmonate biological | |
| | mimic. Loosens mature citrus fruit | |
| | (Burns et al., 2003). Causes transient | |
| | chlorosis. Expect ~10% defoliation. | |
| | Does not cause young fruit | |
| | abscission. | |
| Dikegulac | A pinching agent. In citrus, is | 20, 200, 1000, and 2000 ppm |
| | thought to disrupt auxin-ethylene | |
| | balance and accelerate abscission | |
| | (Pozo et al, 2004). Expect 15-20% | |
| | leaf loss at certain times of the | |
| | season. | |
| Maxcel | Benzyladenine, used as an apple | 20, 200, and 600 ppm |
| | thinning agent (Dennis and Hull, | |
| | 2003). | |
| Methyl jasmonate | A natural compound found in plants. | 0, 0.2, 2, 10 and 20 mM; |
| | | about 0, 45, 445, 2240, and |
| | | 4485 ppm |
| VBC-30050 | Proprietary compound | 20, 200, and 500 ppm |

### Results

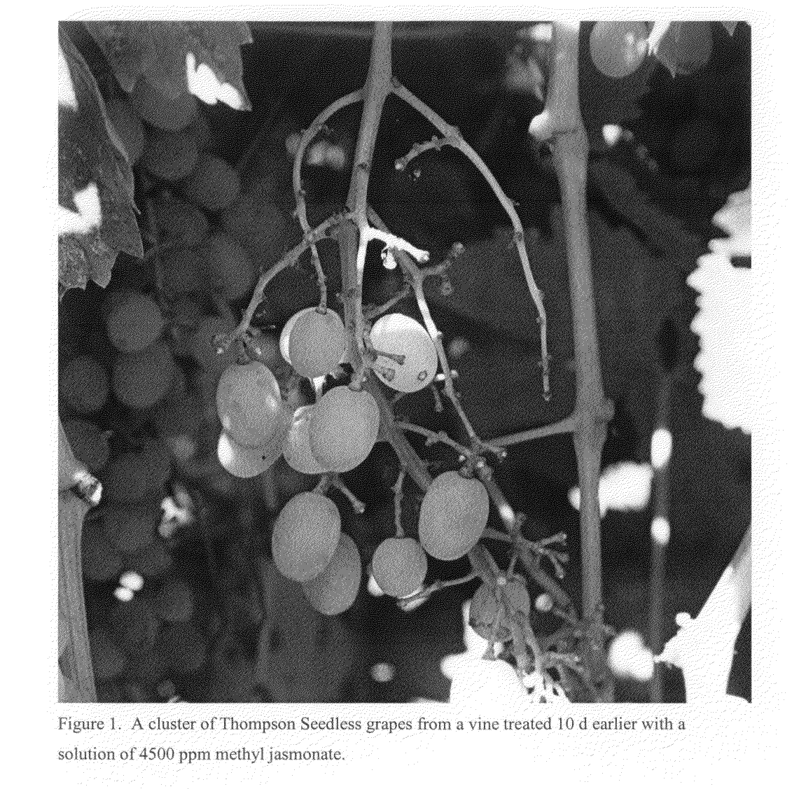

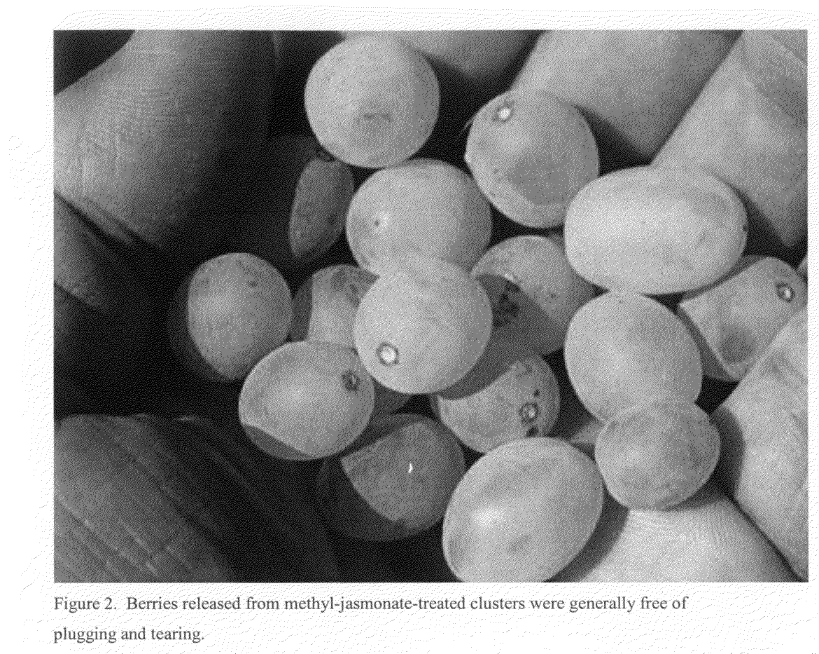

Within 2 days after treatment (DAT), abscised berries were observed in plots treated with ≧450 ppm (2 mM) MeJA (data not shown). Berries abscised at the pedicel/fruit interface, leaving a dry, corky, concave scar on the surface of the abscission zone located at the stem end of each berry (FIG. 1). Released berries were free of stem-end tears and other surface damages (FIG. 2). At harvest, 10 DAT, fruit drop was only observed in plots treated with MeJA or coronatine, so it was only evaluated in those plots and in the control and HP plots. Twenty five percent of the berries from vines in plots treated with 2250 ppm MeJA, and 50% of the berries from vines treated with 4500 ppm MeJA, abscised within 10 DAT (Table 2).

These results are comparable to citrus, when trees treated with solutions of 2250-4500 ppm MeJA had FDF that was 75-80% less than fruit from non-treated trees, and about 20% of the fruit on treated trees dropped within 10 DAT (Hartmond et al., J. Amer. Soc. Hort. Sci. 125:547-552 (2000)). Plots treated with 200 ppm coronatine, a biological mimic of MeJA shown to have abscission activity (Burns et al., J. Amer. Soc. Hort. Sci. 128:309-315 (2003)), were inadequately replicated to analyze statistically due to insufficient material, but fruit drop appeared similar to that of vines treated with 2250 ppm MeJA. About two thirds of the different solutions tested reduced FDF to some degree (Table 3), but the MeJA treatments were distinctive in causing fruit drop, that the lowest concentration tested reduced FDF by half compared to that of non-treated vines, and FDF continued to decrease as the concentration of MeJA increased. Any concentration of MeJA≧450 ppm reduced FDF at least as effectively as cane severance, the current industry standard method. Moreover, MeJA-treated fruit were free of pedicels, whereas numerous fruit harvested from cane severed plots contained cap-stems.

Most compounds tested also caused less canopy damage than harvest pruning, a process that destroys about 50% of the canopy leaf area (Scholefield et al., Sci. Hortic. 7:115-122 (1977)). In fact, the appearance of vines treated with 450 ppm MeJA was similar to that of control vines (Table 4). Treatment with 450 ppm MeJA reduced FDF as effectively as harvest pruning, without causing unwanted berry abscission or canopy damage. Moreover, neither bud break, nor shoot growth the following spring, was affected by any of the treatments (data not shown). However, shoots from vines treated with 2000 ppm dikegulac had cupped leaves and short internodes when evaluated six months later.

TABLE 2
Percent fruit drop (dry wt/dry wt) from Thompson Seedless grapevines
in plots subjected to harvest pruning or to application of solutions
containing 0 (control), 45, 450, 2250, or 4500 ppm methyl jasmonate
(MeJA). Data were collected 10 days after treatment.

| Treatment | Percent fruit drop |
|---|---|
| Harvest Prune | 0.21 c^{z} |
| Control | 0.16 c |
| MeJA (45 ppm) | 0.26 c |
| MeJA (450 ppm) | 6.37 c |
| MeJA (2250 ppm) | 26.85 b |
| MeJA (4500 ppm) | 50.71 a |

^{z}Values are treatment means, n = 4. Means followed by a different letter are significantly different according to Duncan's New Multiple Range Test.

TABLE 3
The effect of different potential abscission
agents on fruit detachment force of Thompson
Seedless grapevines ten days after treatment.

| Treatment | FDF (kg) |
|---|---|
| VBC-30050 (20 ppm) | 0.318 a^{z} |
| Control | 0.317 ab |
| Dikegulac (20 ppm) | 0.291 abc |
| Dikegulac (1000 ppm) | 0.288 ab |
| Dikegulac (200 ppm) | 0.27 ab |
| VBC-30069 (150 ppm) | 0.266 abcd |
| VBC-30050 (20 ppm) | 0.263 bcd |
| VBC-30069 (50 ppm) | 0.261 cd |
| Maxcell (20 ppm) | 0.261 cd |
| Maxcell (600 ppm) | 0.257 cd |
| CMNP (20 ppm) | 0.244 cd |
| VBC-30050 (200 ppm) | 0.243 cd |
| VBC-30050 (500 ppm) | 0.239 cd |
| Maxcell (200 ppm) | 0.226 de |
| CMNP (2000 ppm) | 0.182 ef |
| Dikegulac (2000 ppm) | 0.176 efg |
| Methyl Jasmonate (45 ppm) | 0.169 fg |
| CMNP (1000 ppm) | 0.161 fg |
| CMNP (200 ppm) | 0.156 fg |
| Methyl Jasmonate (450 ppm) | 0.124 gh |
| Harvest Prune | 0.101 hi |
| Methyl Jasmonate (2250 ppm) | 0.079 hi |
| Methyl Jasmonate (4500 ppm) | 0.052 i |

^{z}Values are treatment means, n = 4. Means followed by a different letter are significantly different according to Duncan's New Multiple Range Test.

TABLE 4
The effect of different potential abscission agents on canopy damage
of Thompson Seedless grapevines ten days after treatment.

| Treatment | Canopy damage (0-3; none-severe) |
|---|---|
| Harvest Prune | 3.00 a^{z} |
| CMNP (2000 ppm) | 2.75 a |
| Methyl Jasmonate (4500 ppm) | 2.25 ab |
| Methyl Jasmonate (2250 ppm) | 1.75 bc |
| CMNP (1000 ppm) | 1.75 bc |
| Dikegulac (2000 ppm) | 1.50 bcd |
| CMNP (20 ppm) | 1.25 cde |
| VBC-30069 (150 ppm) | 1.25 bcd |
| Dikegulac (200 ppm) | 1.25 bcd |
| CMNP (200 ppm) | 1.25 bcd |
| Maxcell (600 ppm) | 1.25 bcd |
| Methyl Jasmonate (45 ppm) | 1.00 cd |
| Methyl Jasmonate (450 ppm) | 1.00 cd |
| Dikegulac (20 ppm) | 1.00 cd |
| VBC-30050 (50 ppm) | 1.00 cd |
| VBC-30050 (200 ppm) | 0.75 cd |
| VBC-30050 (500 ppm) | 0.75 cd |
| VBC-30050 (20 ppm) | 0.75 cd |
| Control | 0.75 cd |
| VBC-30069 (50 ppm) | 0.667 d |
| Dikegulac (1000 ppm) | 0.500 d |
| Maxcell (20 ppm) | 0.500 d |

^{z}Values are treatment means, n = 4. Means followed by a different letter are significantly different according to Duncan's New Multiple Range Test.

### Example 2

### Crimson Seedless Experiment

### Materials and Methods

An experiment was conducted in a fourteen-year-old vineyard of own-rooted Crimson Seedless grapes on an open-gable trellis. Individual clusters of grapes were sprayed to runoff with one of four solutions containing 0, 1125, 2250, or 4500 ppm MeJA and an adjuvant (0.2% v/v, Latron-B 1956). On Day 0, treatments were applied in a randomized, complete block design with clusters as observational units, and vines as blocks. Each spray treatment was applied to 4 replicate clusters. During treatment, clusters were surrounded with plastic shields to protect other clusters from overspray and runoff. The day after treatment, each cluster was enclosed in a plastic mesh bag to collect any berries that might abscise. Clusters were harvested 14 DAT. Ten rachis sections were collected from each cluster and FDF was measured as described previously. The condition of the detached berries was noted, and the berries from each cluster were then separately weighed and homogenized in a blender. Juices were filtered and soluble solids, pH, and titratable acidity of the filtered juices were determined using standard methods.

All data were subjected to analysis of variance using the general linear models procedure (PROC GLM) of SAS statistical software (SAS Inst., Cary, N.C.). Duncan's New Multiple Range Test was used to separate treatment means. To determine the relationship between FDF and the concentration of MeJA applied, treatment means were subjected to regression analysis (Gomez and Gomez, Statistical Procedures for Agricultural Research, Wiley Interscience, N.J. (1984)) using SigmaPlot software (Systat Software Inc., Point Richmond, Calif.).

### Results

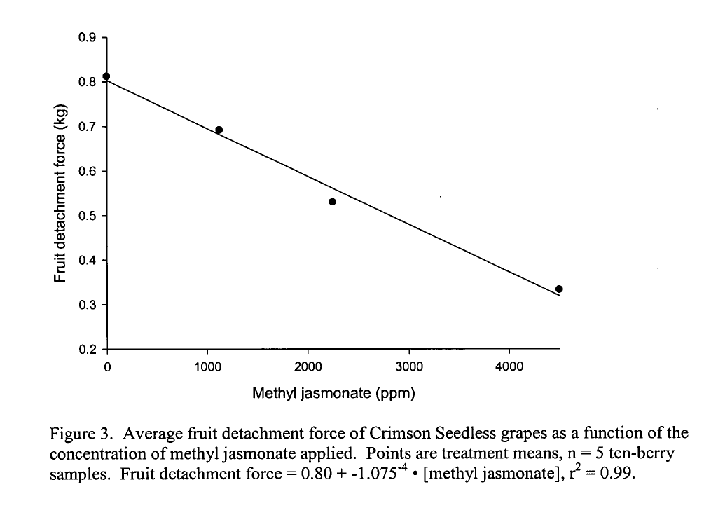

Crimson Seedless grapes did not abscise from any clusters within 14 DAT, but the highest concentration of MeJA loosened some berries sufficiently that the handling involved in harvesting the clusters caused them to detach. For berries retained after harvest, FDF decreased as a linear function of the concentration of MeJA applied (FIG. 3). These results suggest that MeJA acts directly on the target organs, and foliar sprays are not necessary to promote loosening of grapes, an observation that has also been made for citrus (Hartmond et al., 2000). Berries detached from clusters treated with higher concentrations of MeJA generally sustained less mechanical damage from hand harvest such as tearing the skin around the pedicel/fruit attachment point than berries from clusters that were not treated with MeJA. This effect could facilitate preparation of sound individual grape berries for use in the food service industry, or for retail sale.

As observed in Thompson Seedless, berries detached from clusters treated with MeJA formed an abscission layer so the stem ends of the berries usually had a dry, corky, concave scar. Treatment with MeJA did not affect berry fresh weight, but application of >2250 ppm MeJA slightly reduced juice soluble solids (Table 5). Treatment with MeJA did not appear to have any other effects on Crimson Seedless berries.

TABLE 5
Fresh weight and soluble solids of Crimson Seedless berries
from clusters treated fourteen days earlier with 0, 1125,
2250, or 4500 ppm methyl jasmonate (MeJA).

| | | Soluble solids |
|---|---|---|
| Treatment, ppm MeJA | Berry wt (g) | (Brix) |
| 0 | 5.85^{z} | 20.22 a |
| 1125 | 5.41 | 19.76 ab |
| 2250 | 5.96 | 19.30 b |
| 4500 | 5.54 | 19.28 b |

^{z}Values are treatment means, n = 5 ten-berry samples. Means followed by a different letter are significantly different according to Duncan's New Multiple Range Test.

### Example 3

### Cabernet Sauvignon and Merlot Experiment

### Materials and Methods

An experiment was conducted in a nine-year-old vineyard of own-rooted Cabernet Sauvignon and Merlot grapevines on a vertical two-wire trellis. Whole vines were sprayed to runoff on Day 0 with solutions containing 0 or 4500 ppm MeJA and an adjuvant (Latron B-1956; 0.2% v/v) in a completely randomized design replicated four times. On 14 DAT, four representative clusters were collected from each of four vines and ten rachis sections were prepared from each cluster. Fruit detachment force was measured from berries attached to each section, as described previously. Condition of the detached berries was noted, and all the berries from each cluster were counted, weighed, and homogenized in a blender. The juice from each sample was filtered and soluble solids, pH, and titratable acidity of the filtered juices were determined using standard methods. All data were subjected to analysis of variance using the general linear models procedure (PROC GLM) of SAS statistical software (SAS Inst., Cary, N.C.). Duncan's New Multiple Range Test was used to separate treatment means.

### Results

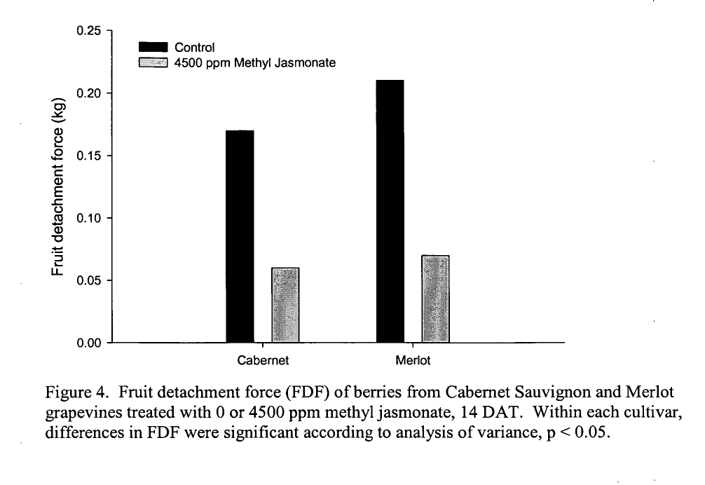

Treatment with 4500 ppm MeJA reduced FDF of Cabernet Sauvignon and Merlot by 66% and 75%, respectively, compared to non-treated vines (FIG. 4). The degree to which MeJA reduced FDF of these grape cultivars is comparable to reductions in FDF noted for Thompson Seedless grapes, as noted above, and Valencia oranges (Hartmond et al., 2000). Treatment with MeJA induced some fruit drop in Cabernet Sauvignon and Merlot, but it appeared to be less than 10% and was not measured. Abscised berries, and most berries detached from treated vines, had formed an abscission layer as described for Thompson Seedless and Crimson Seedless. The fruit loosening effect of MeJA on wine grapes could improve the yield and quality if it enables less aggressive mechanical harvesting so that mechanical damage to machine harvested fruit is reduced and if less ‘material other than grape’, such as rachis and leaves, are sent to the winery (Meyer, Amer J Enol Vitic 108-117 (1969)). Juice from grapes damaged during harvest may oxidize or ferment before being delivered to the winery (Meyer, 1969).

Cabernet Sauvignon berries treated with 4500 ppm MeJA were larger, and their juice had less titratable acidity and a higher pH than non-treated berries, but treatment did not significantly affect those variables in Merlot (Table 6). The wine grapes were treated and harvested at lower soluble solids than necessary for winemaking (≧24 Brix) so that berry phenology was similar to that of Thompson Seedless and Crimson Seedless when those grapes were treated and harvested.

TABLE 6
The fresh weight, Brix, titratable acidity (TA), and
pH of berries from Cabernet Sauvignon and Merlot grapevines
treated with solutions of 0 or 4500 ppm methyl jasmonate
(MeJA) fourteen days after treatment.

| | ‘Cabernet Sauvignon’ | | | | ‘Merlot’ | | | |
|---|---|---|---|---|---|---|---|---|
| | berry | | | | berry | | | |
| Treatment, | wt | | TA | | wt | | TA | |
| ppm MeJA | (g) | Brix | (g/L) | pH | (g) | Brix | (g/L) | pH |
| 0 | 1.40^{z} | 19.7 | 0.63 | 3.77 | 1.76 | 23.11 | 0.45 | 3.97 |
| 4500 | 1.57 | 19.4 | 0.52 | 3.86 | 1.77 | 22.82 | 0.46 | 3.98 |
| P > F | 0.002 | 0.22 | 0.001 | 0.001 | 0.85 | 0.25 | 0.28 | 0.39 |

^{z}Values are means of four samples each consisting of four whole-clusters.

In conclusion, application of MeJA was shown to promote loosening of mature grape berries. Loosened grapes that abscised or detached from clusters were generally in better physical condition than non-treated grapes. This finding suggests that MeJA treatment improves the quality of machine-harvested grapes. The treatments had little effect on leaves, especially at the lower concentrations that would be most likely to have commercial application.

It is understood that the examples and embodiments described herein are for illustrative purposes only and that various modifications or changes in light thereof will be suggested to persons skilled in the art and are to be included within the spirit and purview of this application and scope of the appended claims.

All publications and patent applications cited in this specification are herein incorporated by reference as if each individual publication or patent application were specifically and individually indicated to be incorporated by reference.

What is claimed is:

1. A method of harvesting grapes, comprising the steps of:
contacting a fruiting grape plant with a composition comprising methyl jasmonate (MeJA), or an analog thereof; and
harvesting the grapes,
wherein the concentration of MeJA or analog is sufficient to reduce the fruit detachment force (FDF) required to harvest the grapes as compared to that of an untreated plant.

2. The method of claim 1, wherein the composition further comprises an adjuvant.

3. The method of claim 2, wherein the adjuvant is Latron B 1956.

4. The method of claim 2, wherein the adjuvant is between 0.01% and 1% volume/volume of the composition.

5. The method of claim 2, wherein the adjuvant is between 0.1% and 0.5% volume/volume of the composition.

6. The method of claim 1, wherein the concentration of MeJA, or analog thereof, is between 0.1 mM and 50 mM in the composition.

7. The method of claim 1, wherein the concentration of MeJA, or analog thereof, is between 0.2 mM and 20 mM in the composition.

8. The method of claim 1, wherein the concentration of MeJA, or analog thereof, is between 2 mM and 20 mM in the composition.

9. The method of claim 1, wherein the concentration of MeJA, or analog thereof, is greater than 10 mM in the composition.

10. The method of claim 1, wherein harvesting comprises applying at least 10% less FDF than required to harvest untreated grapes.

11. The method of claim 1, wherein harvesting comprises applying at least 50% less FDF than required to harvest untreated grapes.

12. The method of claim 1, wherein harvesting comprises collecting grapes that have separated from the stem.

13. The method of claim 1, wherein the grapes are harvested no more than one month after said contacting step.

14. The method of claim 1, wherein the grapes are harvested no more than 14 days after said contacting step.

15. The method of claim 1, wherein the grapes are harvested no more than 10 days after said contacting step.

16. The method of claim 1, wherein the grapes are table grapes.

17. The method of claim 1, wherein the harvested grapes are crushed for juice or wine production.

18. The method of claim 1, wherein the harvested grapes are dried for raisin production.

19. The method of claim 1, wherein harvesting comprises shaking.

20. The method of claim 1, wherein harvesting comprises handling.

21. The method of claim 1, wherein the analog is jasmonic acid.

22. A composition for the treatment of grapes, the composition comprising methyl jasmonate (MeJA), or an analog thereof, and Latron B 1956.

23. The composition of claim 22, wherein the concentration of MeJA or analog is between 0.1 mM and 50 mM.

24. The composition of claim 22, wherein the concentration of MeJA or analog is between 0.2 mM and 20 mM.

25. The composition of claim 22, wherein the concentration of MeJA or analog is between 2 mM and 20 mM.

26. The composition of claim 22, wherein the concentration of MeJA or analog is greater than 10 mM.

27. The composition of claim 22, wherein Latron B 1956 is between 0.01% and 5% volume/volume of the composition.

28. The composition of claim 22, wherein Latron B 1956 is between 0.1% and 1% volume/volume of the composition.

29. The composition of claim 22, wherein the analog is jasmonic acid.
